(19) United States
(12) Patent Application Publication
(10) Pub. No.: US 2005/0262399 A1
(43) Pub. Date: Nov. 24, 2005

(54) Aggregating and prioritizing failure signatures by a parsing program

(76) Inventors: Adam C. Brown, Windsor, CO (US); Jeremy P. Petsinger, Fort Collins, CO (US); Danny Kwong, Fort Collins, CO (US)

Correspondence Address: HEWLETT-PACKARD COMPANY;Intellectual Property Administration, P.O. BOX 272400, Fort Collins, CO, 80527-2400, US

(21) Appl. No.: 11/089,564

(22) Filed: May 5, 2004

(51) Int. Cl. G06F 11/00

(52) U.S. Cl. 714/38

(57) ABSTRACT

In one embodiment, a failure signature is received into a parsing program. The parsing program aggregates the failure signature into a failure mode, and prioritizes the failure mode according to a hierarchy. A failure mode is received into a triaging program, the triaging program determines that the failure mode corresponds to a diagnosis, and records the failure mode in a directory corresponding to the diagnosis.

### BACKGROUND

Before a hardware design, e.g. a microprocessor, microcontroller, application specific integrated circuit (ASIC), or the like is manufactured in silicon, a behavioral model of the design is usually written and tested. This behavioral model may be implemented using a hardware description language, such as Very High-Speed Integrated Circuit Hardware Description Language (VHDL), Verilog, etc. The behavioral model may then be tested for correctness by any of a number of methods. The testing method may be referred to as “verification.”

One method of performing verification is to create a reference model, which is capable of independently and correctly outputting the expected results of the design under test. Often, a code generator is used to input the same test code sequence (or “input vector”) into both the reference model and the behavioral model. The output of each model is then compared with the output of the other model, and any differences are indicated as errors.

Early in the design process, when there are typically a large number and type of differences between the behavioral and reference models, or late in the design process when very large numbers of test vectors are run, there may be a significant number of cases or test vectors in which the behavioral and reference models output different results. These differences are called “failures.”

Identifying unique failures can be a difficult and time-consuming task, which usually requires detailed knowledge of the design under test. A single failure may manifest itself in a number of different ways, with different failure signatures, wherein a failure signature may be considered to be an output of a testing system indicating a particular error. For example, an underlying failure may show up as an error in a register, and that error may be propagated if the input vector contains instructions which direct the design under test to use the information stored in that register for a subsequent calculation. The underlying failure may then manifest itself in several different failure signatures output by the testing system, each one corresponding to a particular occurrence of propagation of the first register error resulting from the failure.

One traditional solution for identifying and managing failures has been for the design engineer or test engineer to inspect and sort each failure individually based on failure signatures output by the testing system. This method can be extremely time-intensive and may severely limit the number of failures one engineer can evaluate. In addition, it can be very difficult and time-consuming to sort and manage a large number of failures, and more importantly, to identify which failure signatures may indicate new and unique failures. Traditional testing systems simply report failure signatures as output by the reference and behavioral models. Therefore, if one particular test vector reveals multiple failures, or if many vectors fail with different failure signatures but due to the same underlying cause, such reporting schemes may be confusing or frustrating to a test engineer. Such reporting schemes may result in improper or inefficient classification of failures.

### SUMMARY

According to at least one embodiment, a method comprises receiving a failure signature into a parsing program, aggregating the failure signature into a corresponding failure mode, and prioritizing by the parsing program the failure mode according to a hierarchy.

Further, according to at least one embodiment, a method comprises receiving a failure mode into a triaging program, determining by the triaging program that the failure mode corresponds to a diagnosis, and recording the failure mode in a directory corresponding to the diagnosis.

### BRIEF DESCRIPTION OF THE DRAWINGS

FIG. 1 depicts an exemplary system for implementing a parsing program and a triaging program according to an embodiment;

FIG. 2 depicts an exemplary operational flow for a parsing program according to an embodiment;

FIG. 3 depicts an exemplary operational flow for a triaging program according to an embodiment;

FIG. 4 depicts an exemplary operational flow for revising operating characteristics of a parsing program or triaging program according to an embodiment;

FIG. 5 depicts an exemplary system adapted to implement a parsing program and a triaging program according to an embodiment;

FIG. 6 depicts an exemplary operational flow for tracking failures according to an embodiment;

FIG. 7 depicts an exemplary operational flow for performing regression according to an embodiment;

FIG. 8 depicts an exemplary operational flow for running a parsing program according to an embodiment;

FIG. 9 depicts an exemplary operational flow for running a triaging program according to an embodiment; and

FIG. 10 depicts an exemplary system adapted to implement a parsing program and a triaging program according to an embodiment.

### DETAILED DESCRIPTION

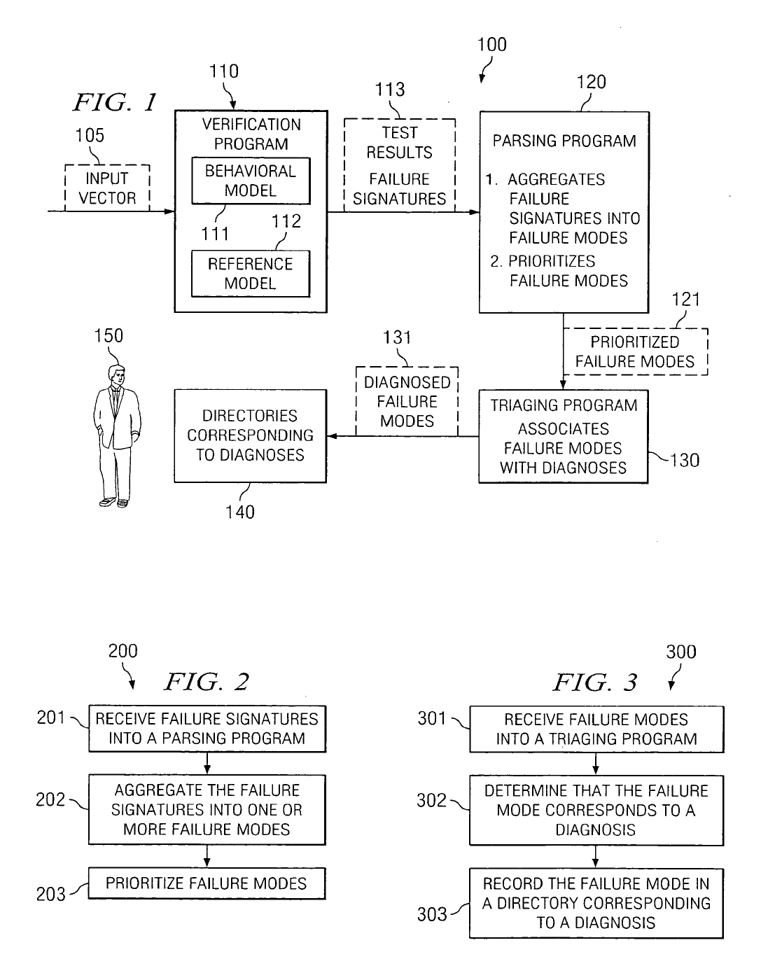

FIG. 1 depicts exemplary system 100 for implementing a parsing program and a triaging program according to at least one embodiment. Verification program 110 includes behavioral model 111 and reference model 112. Input vector 105 is input into verification program 110 and run by behavioral model 111 and reference model 112. The outputs of behavioral model 111 and reference model 112 are compared, as explained above, and test results 113 are output by verification program 110. Test results 113 includes failure signatures.

Test results 113 are input into parsing program 120. Parsing program 120 contains code instructing program 120 to aggregate failure signatures from results 113 into corresponding failure modes and to prioritize those failure modes according to a hierarchy. Parsing program 120 then aggregates those failure signatures into failure modes and prioritizes those failure modes before it outputs prioritized failure modes 121 to triaging program 130.

Triaging program 130 receives prioritized failure modes 121 from parsing program 120. Triaging program 130 contains code instructing it to associate some of the failure modes with corresponding diagnoses. Triaging program 130 then associates some of the failure modes with diagnoses and saves diagnosed failure modes 131 to directories 140 corresponding to those diagnoses. Accordingly, each directory corresponds to a diagnosis, and modes that share a similar diagnosis are saved in the same directory. Test engineer 150 may then access directories 140 to inspect the failure modes.

FIG. 2 depicts an exemplary operational flow diagram 200 for a parsing program according to an embodiment. In operational block 201, failure signatures are received into a parsing program. In certain implementations, the failure signatures are received into the parsing program through use of a test results file. That is, after a testing system compares the outputs of the reference and behavioral models, it saves those results in a test results file in certain implementations. The parsing program then receives and opens the test results file and examines the results and the failure signatures included therein. Examining the failure signatures may include detecting and logging the failure signatures from the results file, as examples.

After all of the failure signatures in the results file have been detected and logged, the failure signatures are aggregated into one or more failure modes in operational block 202. The parsing program begins aggregation by detecting patterns (correlation) in the failure signatures that have been logged. For example, in certain implementations the parsing program compares a failure signature that has been logged to the previous failure signatures that have been logged to determine any correlation. The parsing program eventually checks each failure signature against every other failure signature such that any correlations that exist may be found and recorded. Correlations in the failure signatures may mean that the failure signatures share a common root cause, for instance. For example, two general registers may mismatch because of the same hardware failure, and the parsing program detects correlation in those failure signatures (as being caused by the same hardware failure).

Failure signatures that are found to correlate by this example implementation of the parsing program are aggregated by the parsing program into failure modes. For example, after the parsing program has determined that the general register mismatches are correlated, the parsing program aggregates those two failure signatures together into a common failure mode. If later, the parsing program determines that a third mismatch correlates to the first two, the parsing program further aggregates that third failure signature into the same failure mode. The failure modes may then be logged.

A failure signature that does not correlate to any other failure signature in operational block 202 is assigned to a failure mode unique to that signature, such that every failure signature is assigned to a failure mode. Alternatively, a test engineer may instruct the parsing program not to assign unique modes to non-correlating signatures (e.g. all non-correlating signatures may be grouped into a common failure mode). Embodiments may allow any manner of handling non-correlating signatures and may allow a test engineer to instruct the program to handle the signatures in such manner.

In certain embodiments, a test engineer determines which failure signatures the parsing program is to aggregate in operational block 202. For example, a test engineer may determine that certain failure signatures in the hardware most likely share a common cause, and as such, the test engineer may input into the parsing program information (e.g., a database of criteria) defining those failure signatures as correlating. The program may then check that information (e.g., database) and aggregate failure signatures according to the test engineer's instructions. In certain embodiments that aggregation of failure signatures may be a case-by-case determination that is different for every system under test. As such, an exemplary parsing program allows a test engineer to customize aggregation instructions for each design under test according to his knowledge of failure signatures in that particular design.

In certain embodiments, the parsing program aggregates some failure signatures without specific instructions from the engineer to aggregate such signatures in operational block 202. In an example implementation of such an embodiment, the parsing program detects when a register failure is propagated throughout a test vector run. Such a parsing program recognizes when the underlying error first occurs and has enough information (e.g., in a database) about the architecture of the system under test and the instructions in the test vector that it can recognize that the error is propagated throughout other registers. Without specific instructions from the test engineer, this example implementation of the parsing program aggregates those failure signatures caused by the underlying error into a failure mode.

After the parsing program has determined that it has checked the signatures and logged the failure modes, it prioritizes the failure modes in operational block 203. According to at least one embodiment, such prioritizing includes determining which failure modes are more important and then preparing to present to a user a list of failure modes with the most important ones listed first. In certain implementations, prioritizing in block 203 also includes determining which failure modes are the least important and preparing to present them to the user in a list with those failure modes at the bottom of the list. In other implementations, prioritizing in block 203 includes not presenting the least important failure modes to the user at all.

In certain embodiments of the parsing program, a test engineer determines how the program will prioritize the failure modes in block 203. In one such embodiment, a test engineer determines through experience which failure modes he believes are most severe, and therefore, deserve attention before other failure modes (i.e., are to be prioritized higher). The test engineer inputs into the parsing program criteria defining a hierarchical organization of failure mode priorities such that the parsing program outputs the failure modes according to the test engineer's hierarchy. The parsing program allows the test engineer to go back later and change the hierarchy to reflect a change in beliefs about which failure modes are most important. In such an embodiment the hierarchical organization may be changed multiple times throughout testing of the design.

As an example of a specific application of a parsing program operating in accordance with the flow of FIG. 2, consider a system under test being a microchip which contains a translation structure, for translating virtual addresses to physical addresses, commonly referred to as a Translation Look-aside Buffer (TLB). Suppose an instruction in the testing system, called “PURGE_TLB,” instructs the system under test to delete the contents of the entire TLB. In this example, this system under test is prone to a bug which causes the contents of the TLB not to be deleted even though the PURGE_TLB instruction has been executed. The bug may occur as follows: A virtual address to be translated is inserted into the TLB. Two clock cycles later, a PURGE_TLB instruction is encountered and executed. Because the translation of the received virtual address takes more than two clock cycles to complete, the TLB fails to purge the translation. The test engineer is aware of this bug in this example microchip design and programs the parsing program such that when the parsing program encounters a failure signature with symptoms similar to an occurrence of this bug, the program recognizes that this bug may have occurred (e.g. recognizes this bug as a potential root cause or failure mode).

A test vector is used for testing the microchip design, and the results of such testing are stored to a results file. In block 201, failure signatures are input into the parsing program via the results file. The parsing program opens the results file, which contains information about the state of the chip at a given cycle, such that the parsing program may read this information and use it to recognize that there was an insertion of a virtual address to the TLB two cycles before execution of the PURGE_TLB instruction. When the parsing program encounters a failure signature from a verification program, the parsing program is able to recognize the symptoms and determine that the failure signature is probably due to the above-described bug. The parsing program then associates the failure signature with this bug's symptoms, and the program will check the other signatures that it encounters. Later signatures that are associated with the same occurrence of the bug symptoms are logged into the same failure mode (aggregated) with the first signature, as in operational block 202.

Correlating the failure signatures appearing in the results of the testing of a behavioral model, in block 202, according to known bug symptoms is one way that failure signatures may be aggregated by the parsing program. Additionally or alternatively, failure signatures may be aggregated by the parsing program according to similarities in symptoms that have not yet been associated with any particular bug. In embodiments in which a failure signature is detected and logged but there is no previously defined bug, failure signatures may be aggregated into failure modes in block 202 according to those symptoms, which may aid a test engineer in determining a bug, or root cause, associated with such failure mode.

Next, the parsing program determines a priority for the failure modes that it has logged, as in operational block 203. In this example, suppose the test engineer has decided that the failure modes corresponding to the known TLB bug are of high importance and should be output before the other failure modes. The test engineer has accordingly input into the parsing program criteria defining a hierarchy with the TLB bug failure mode at the top of that hierarchy. When the parsing program prioritizes the failure modes in operational block 103, it recognizes the failure mode associated with the TLB bug and accordingly assigns it a high importance. When the failure modes are output, the TLB bug failure mode detected in the test results will be listed before the other logged failure modes, for instance.

In similar embodiments, the test engineer may input instructions into the parsing program instructing the program to associate a failure mode with a known bug and to identify that failure mode as associated with that bug. Referring to the above TLB bug example, the bug may be referred to as “Bug 16090.” When outputting the failure modes the parsing program may associate the failure modes involving the TLB bug symptoms with Bug 16090 and may mark in the failure modes that they are associated with Bug 16090.

Further, in certain embodiments, the failure signatures in the failure modes are accompanied by system status information (e.g. clock cycles, instructions encountered, etc.). In such an embodiment, the parsing program is capable of providing to an engineer much information to use to examine the failure modes. The information may also reveal upon examination that a failure mode has been defined incorrectly, thereby giving the engineer a tool to check his own work. Any desired helpful information may be included in the output of the parsing program in accordance with various embodiments thereof.

In a similar manner, in certain implementations the parsing program is also operable to search the results file not only for failures, but also for system status information of interest. Referring again to the TLB bug example, if the results file for a test of the behavioral model for this example microprocessor design shows an insertion of a virtual address to the TLB followed by a PURGE_TLB instruction two cycles later, the parsing program may be programmed to save a record of the occurrence irrespective of whether it produced a failure. The program may then output the information to the test engineer, thereby informing the engineer of both failures and potential failures.

FIG. 3 depicts an exemplary operational flow 300 for a triaging program according to an embodiment. The parsing program may be used in conjunction with a triaging program in order to better organize the failure modes for output. In such an embodiment, a triaging program calls the parsing program and asks the parsing program for outputs. The parsing program then outputs the results of the parsing to the triaging program, such that the failure modes are input into the triaging program in operational block 301.

The triaging program then examines each failure mode. The program determines if a diagnosis exists for the failure mode by checking predetermined diagnoses to see if the test engineer has associated that type of failure mode with a corresponding diagnosis. For example, if the parsing program has organized various failure signatures into a common failure mode, “TLB bug,” because it has associated symptoms of Bug 16090 with those failure signatures, and the test engineer has assigned the diagnosis, Bug 16090, in the triaging program to such failure mode, “TLB bug,” then the triaging program determines in operational block 302 that the “TLB bug” failure mode corresponds to the diagnosis. When this ”TLB bug” failure mode is determined by the triaging program to correspond to this diagnosis, then the failure mode is moved to a directory corresponding to the diagnosis in operational block 303. In this example, because the diagnosis, “Bug 16090,” is assigned to the “TLB bug” failure mode, then the triaging program creates a directory named “Bug 16090” and moves that “TLB bug” failure mode and subsequent failure modes assigned the same diagnosis into that directory in block 303.

If it is determined that a failure mode does not correspond to any diagnosis, then in certain implementations the triaging program creates a unique directory for such failure mode, or it may create a common directory for all undiagnosed failure modes. Alternatively, in other implementations, the triaging program does nothing to such a failure mode not corresponding to a diagnosis, such that a testing engineer who wishes to examine the failure mode may do so by examining the results output by the parsing program. In certain embodiments, the triaging program is operable to receive instructions as input that directs the parsing program to handle undiagnosed failure modes in any desired manner, thereby allowing the test engineer to customize handling of the undiagnosed failure modes.

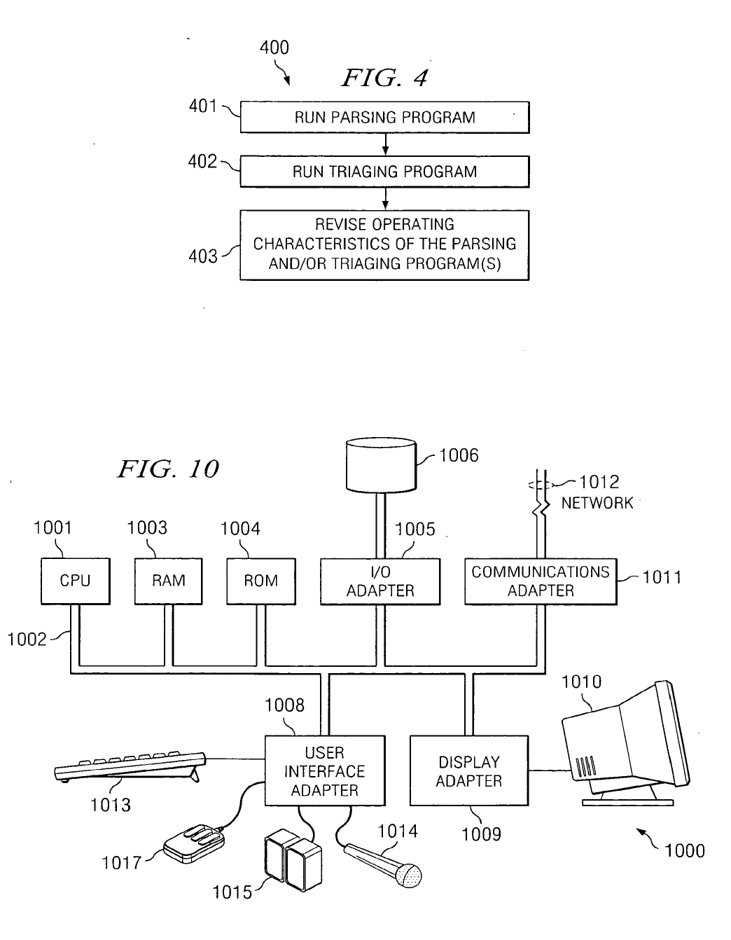

FIG. 4 depicts an exemplary operational flow 400 for revising operating characteristics of a parsing program or triaging program according to an embodiment. In accordance with this example embodiment, the test engineer can revise operating characteristics of the parsing program and/or the triaging program after the programs have run, as in block 403 described below. First, a test engineer runs the parsing program in operational block 401 to obtain prioritized failure modes. Then, the engineer runs the triaging program in operational block 402 to associate various failure modes with corresponding diagnoses and to identify frequently occurring, diagnosed failure modes. The engineer then uses the results from the parsing and triaging programs to inspire changes to those programs, which he may implement in block 403. The engineer may revise operating characteristics after running only one of the parsing and triaging programs in certain situations. The engineer may modify one or more of the programs in block 403 in order to make them responsive to newly discovered bugs, to improve the response to known bugs, and/or to optimize the programs in any way that may assist the engineer in testing the system under test, as examples.

In accordance with embodiments of the parsing and triaging programs, those programs may be used to test software as well as hardware. In other words, the behavioral model may represent the behavior of software, of a hardware design, or combination thereof. For example, a testing system may include as its behavioral model the software version under test and as its reference model a table of expected results with a given test vector. The test vector may then be input in the behavioral model and the results recorded. The results of the behavioral model and the expected results may then be compared to produce a results file that may be processed by the parsing program and/or the triaging program, as described above.

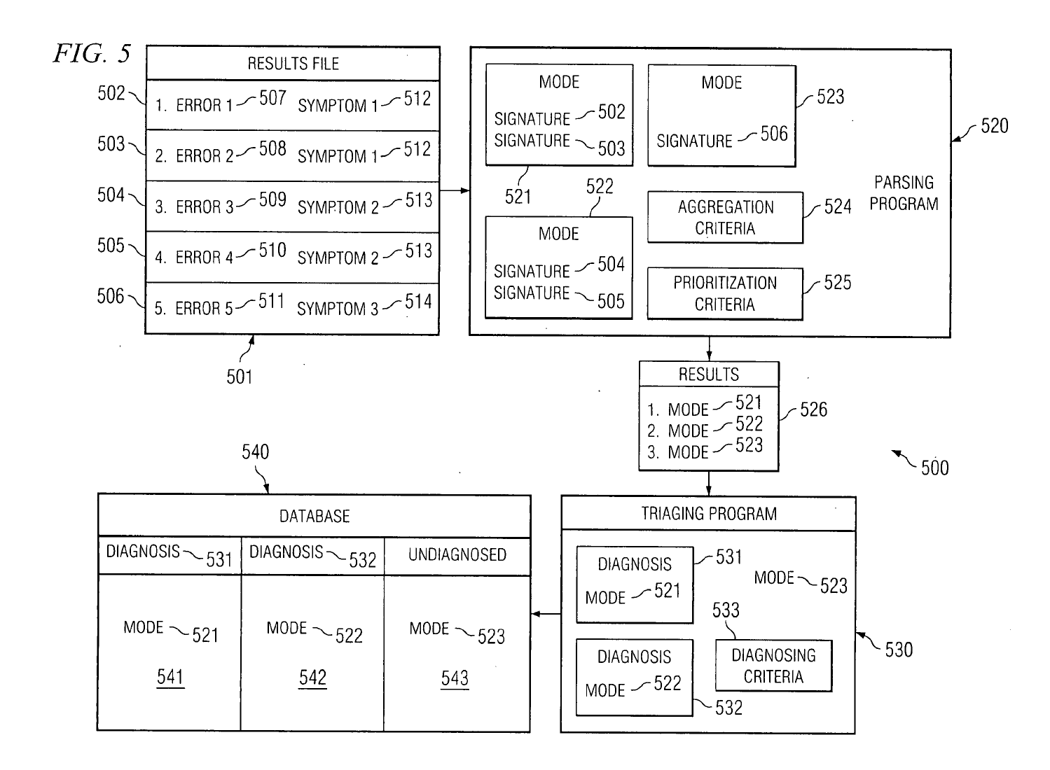

FIG. 5 depicts an exemplary system 500 according to certain embodiments. Results file 501 containing failure signatures 502-506 is generated by testing a behavioral model (not shown) with a test vector (also not shown), and such results file 501 is received into parsing program 520 (as in block 301 of FIG. 3). In this example, each of failure signatures 502-506 arises from a particular error (errors 507-511) and identifies a corresponding symptom(s) (symptoms 512-514). Parsing program 520 examines failure signatures 502-506 to determine which symptoms 512-514 failure signatures 502-506 identify. Symptoms 512-514 identified by failure signatures 502-506 determine which failure modes parsing program 520 will use to organize signatures 502-506, according to aggregation criteria 524. In this example embodiment, criteria, such as aggregation criteria 524, are input by a test engineer. Aggregation criteria 524 associates symptoms to a particular failure mode. Some signatures may show similar symptoms as other signatures, and the parsing program organizes such similar signatures into common failure modes (as in block 302 of FIG. 3). In this example, failure signatures 502 and 503 show symptom 512, failure signatures 504 and 505 show symptom 513, and failure signature 506 shows symptom 514. Accordingly, parsing program 520 organizes failure signatures 502 and 503 into failure mode 521 and organizes failure signatures 504 and 505 into failure mode 522. In this embodiment, failure signature 506 is a unique failure mode, and this example system organizes failure signature 506 into unique mode 523.

Parsing program 520 then uses prioritization criteria 525 to prioritize the failure modes (as in block 303 of FIG. 3). Failure modes with a low assigned priority may be output to a test engineer toward the bottom of a list or may not be output to a test engineer at all, as examples. Prioritization criteria 525 reflects the empirical data regarding the importance of each failure mode compared to other modes. In this example, parsing program 520 assigns a higher priority to failure mode 521 than to failure mode 522 and assigns the lowest priority to unique failure modes, such as mode 523, in accordance with prioritization criteria 525. The modes are organized in the parsing program results 526 according to their priorities.

Parsing program 520 then outputs results 526 to triaging program 530. Triaging program 530 checks the failure modes 521, 522, and 523 to determine whether diagnoses exist for modes 521, 522, and 523. To determine whether diagnoses for failure modes 521, 522, and 523 exist, triaging program 530 uses diagnosing criteria 533. In this example, diagnoses exist for failure modes 521 and 522, and triaging program 530 associates failure modes 521 and 522 with their corresponding diagnoses 531 and 532, respectively. Since no diagnosis exists for failure mode 523, triaging program 530 assigns no diagnosis to the mode 523. Then triaging program 530 organizes failure modes 521 and 522 into respective directories 541 and 542 in database 540 according to their respective diagnosis 531 and 532. In this example, triaging program 530 organizes undiagnosed failure modes, such as mode 523, into common directory 543 in database 540.

Certain embodiments disclosed herein provide advantages over traditional testing systems. A first advantage of certain embodiments is that the test engineer does not have to deal with massive and unorganized volumes of failures that result from running numerous test vectors on a behavioral model. A second advantage for certain embodiments is that parsing program 520 can determine the underlying failure based on recognizable information input by the test engineer. Various other advantages may be recognized with embodiments described herein in addition to or instead of these example advantages.

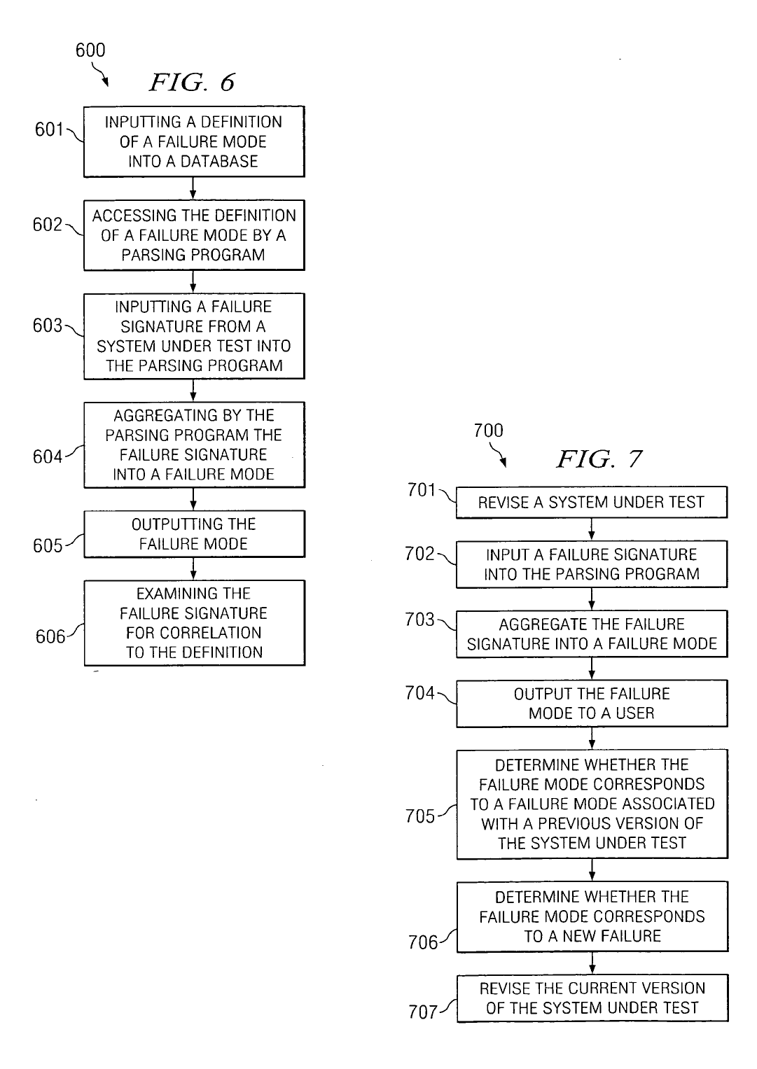

FIG. 6 illustrates an exemplary operational flow for tracking failures according to at least one embodiment. Parsing program 520 may be used for performing operations, such as the one depicted in flow 600. In this example, such embodiment upon submission of a definition of a failure mode(s) into a tracking database, as in operational block 601, parsing program 520 accesses the definition of the mode in block 602. Failure signatures are then input into parsing program 520 in block 603. Parsing program 520 then aggregates the failure signatures therein with the defined failure mode(s) in block 604. The detected failure modes are then output by the parsing program in block 605. Debugging engineers can search the results of parsing program 520 to examine the failure signatures for correlation to the failure mode definition, as in block 606, in order to determine the status of similar and related failure modes, to determine whether a particular failure has already been observed and noted, and/or to aid the engineers in the recognition of a new, but similar, failure mode. The process may, in certain implementations, be automatic, such that parsing program 520 may be automatically run on a failing results file (such as results file 501) and process the results therein according to steps 604 and 605, while in other implementations user input (or some other action) triggers operation of the parsing program 520.

FIG. 7 depicts an exemplary operational flow for performing regression (as explained below) according to an embodiment. Periodically, a system under test is revised, as in block 701, such that the behavioral model is updated to address failures that have been observed in previous versions, for example. To ensure that the new behavioral model does not, in fact, greatly increase the number of failure modes (thereby “regressing” the quality of the model), a suite of test vectors is automatically run on the new model version. The process of testing for regression is often referred to simply as “regression.” Parsing program 520 is utilized in performing regression in this embodiment, such that the failure signatures output from the system under test are input into parsing program 520 in block 702, and are processed in blocks 703 and 704. In block 703, parsing program 520 aggregates the failure signatures into one or more failure modes. In block 704 parsing program 520 outputs the failure modes to a user. Block 704 may include prioritizing the failure modes, as in block 203 of FIG. 2; however, at least one embodiment allows a test engineer to utilize only the aggregation capability of parsing program 520 during regression. The engineer responsible for the regression of a new model uses parsing program 520 to determine, in block 705, whether any failure modes that appear during the model regression are known failures that have not been addressed in the present model revision, and determines in block 706 whether new failure modes have appeared that severely degrade the quality of the behavioral model. If the quality is lower than expected, the regression engineer uses the output of parsing program 520 to locate the source of the new problems so that a revised, corrected behavioral model can be created, as in block 707, and released for testing in an efficient manner.

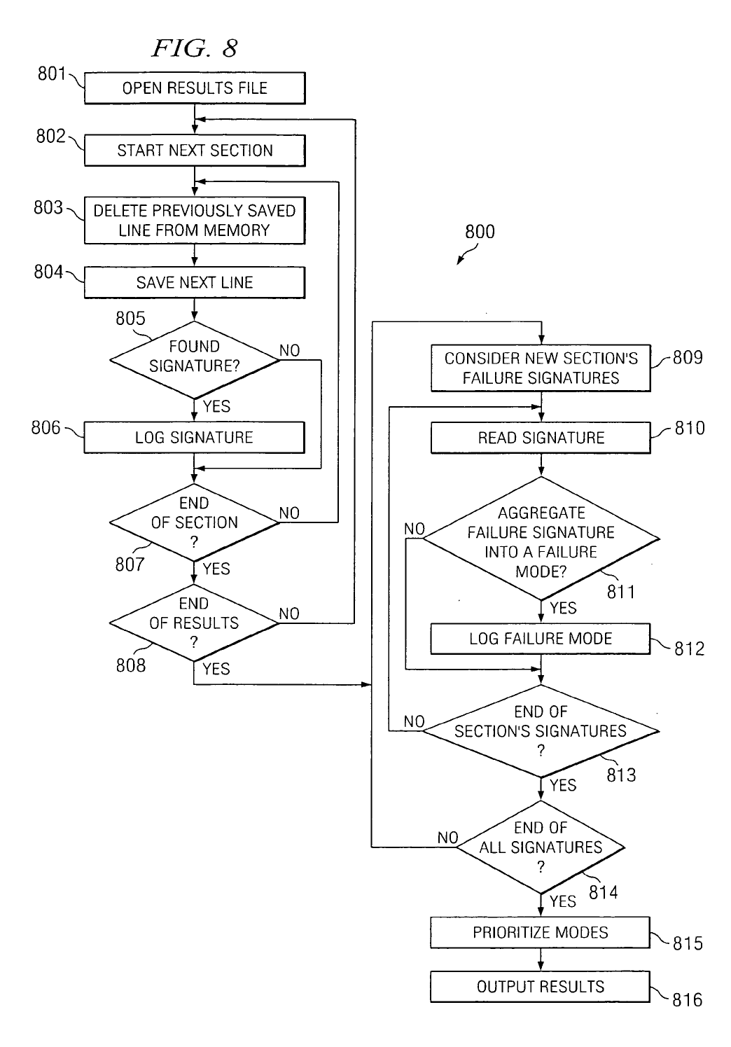

FIG. 8 depicts an exemplary parsing flow 800 implemented in one embodiment of a parsing program. In operational block 801, the parsing program opens the results file that has been input. In block 802, the parsing program starts a new section of the results file. The test results file may be a text file organized into sections that correspond to some organizational scheme of the testing system. For example, the testing system may run several checker programs during each test. Two such checker programs may be a program which tests interfaces between components in a hardware design and a program which tests for correctness of output of the design based on a given input. Other types of checkers also exist and may provide information to a test results file. A number of sections in the test results file may then each correspond to one checker program's results. Further, other sections may be used for storing information that does not specifically correspond to any checker program's results. Such information may include a log of the state of the hardware, such as clock cycles simulated and instructions encountered. The testing results file may include one or more sections organized in any desired way in various embodiments. The parsing program may save and use any information encountered in the results file as desired various embodiments.

The parsing program, according to this example embodiment, starts the next in-line section (which in this first iteration is the first section) in block 802 by deleting a previously-saved line (which in this first iteration may be no line at all) from memory in block 803 and then examining the next in-order line (which in this first iteration is the first line) in the section and saving that line in block 804. The parsing program then searches for an indication that there is a failure signature present in that line in block 805. If, for example, the testing system compares the results of the outputs and marks in a line in a section that there exists a failure signature, then the parsing program may look for the error indication written by the testing program in that line. If the testing program had marked a failure signature in the line being examined, then the parsing program recognizes that there is a failure signature present and logs the failure signature in block 806 as well as which line the failure signature appeared in. After the parsing program checks the line and logs any failure signatures, the program then checks in block 807 to see if it is at the end of a section. If it is not at the end of a section, it then goes back to block 803 to delete the previously-saved line (which in this iteration is the first line in the section) from memory, and then moves on to block 804 to save the next in-order line in the section. If it is at the end of the section, it goes to block 808 where it determines if all sections have been checked. If one or more sections are left to be checked, it begins the next section in block 802, or if all the sections are checked, it moves to block 809.

After all sections have been checked for failure signatures, the program begins examining the failure signatures in each section. In operational block 809, the parsing program begins to consider the failure signatures section-by-section by starting with a new section. In block 810, the program reads a signature that has been logged in block 806. In block 811, the program examines the failure signature to determine if it correlates to any other failure signatures. If the signature does correlate to other signatures, the program aggregates the signature with other signatures into a failure mode, and the failure mode is logged in block 812. If there is no correlation, then the signature is not aggregated. In block 813, the program checks if it is at the end of the section. If it is not at the end of the section, its operation loops back to block 810. If it is at the end of the section, operation advances to block 814 to check if it is at the end of all signatures in all sections. If it is not at the end of all sections, its operation loops back to block 809. If all signatures in all sections have been checked for correlation, then the parsing program prioritizes the failure modes in block 815, and in block 816, the parsing program outputs its results.

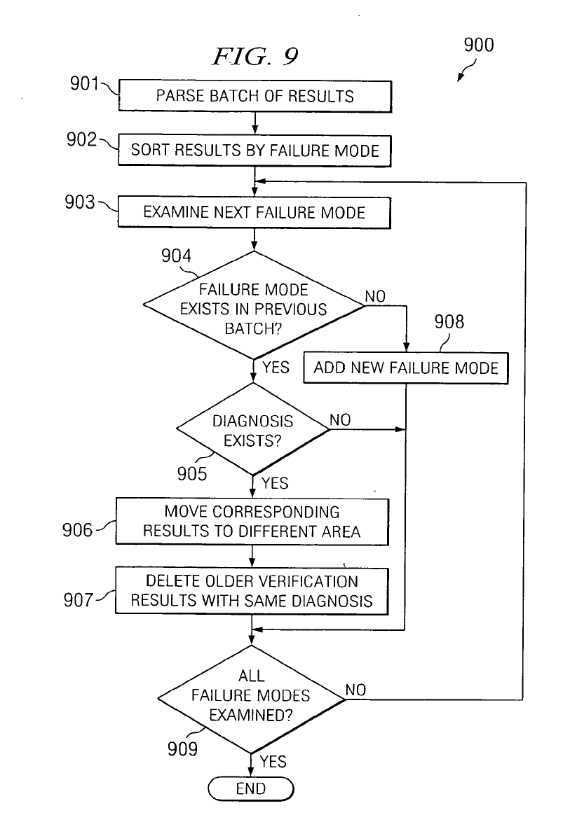

FIG. 9 depicts an exemplary triaging process implemented by one embodiment of triaging program 900. In operational block 901, a batch of results from a verification program are parsed and the output of the parsing program is input into the triaging program. The parsing program may output the results of parsing by batch. When verifying designs, the test engineer may run many test vectors in a group at a particular time. That group of test vectors is referred to as a “batch”. For example, on September 30 at 12:00 noon, a particular batch of 250 test vectors may be run by a verification program. The results of that batch may then be parsed by a parsing program, and then when the triaging program asks the parsing program for outputs, it may ask for the September 30 noon batch. The triaging program may ask for several batches at the same time. In accordance with various embodiments, the triaging program may ask for any number of test results (e.g., a batch of any size).

The triaging program then sorts the results by failure mode in block 902. For example, if there were 250 test vectors run in a batch, there may be 250 results files that have been parsed by the parsing program. If each results file outputs exactly one failure mode, and all of the modes are substantially similar, then the triaging program may sort the failure modes into one group corresponding to the one kind of failure mode. The triaging program then retrieves the next in-line failure mode in block 903. If it is the first iteration of the triaging program, the next in-line failure mode is the first failure mode. Also, if there is only one failure mode, the next in-line failure mode is that mode.

The program then determines if the failure mode (or group of similar failure modes) exists in a previously-triaged batch in block 904. If the failure mode has not been seen in a previously-triaged batch, then the triaging program determines that it is a new mode and adds it to a list of new modes in block 908. If it has been seen in a previously-triaged batch, the triaging program checks if a diagnosis exists in block 905. If a diagnosis does exist, then the program moves the corresponding results to a different area in block 906 by creating a directory for the diagnosis and storing the mode in that directory. In block 906, if a directory already exists for the diagnosis, then the triaging program simply stores the mode in the corresponding directory. In block 907, the triaging program may save memory by deleting from memory the older verification program results which showed the same diagnosis after parsing, such that if the directory contained failure modes from a previous batch, the triaging program deletes those older verification program results corresponding to the older modes, thereby leaving only the most recent results files associated with the given diagnosis. In block 909, the triaging program determines if all failure modes in the batch have been examined. If there are still failure modes left to be examined, then the triaging program loops back to block 903. If all failure modes in the batch have been examined, then the triaging program is finished. A test engineer may choose to output the results or save them for future analysis.

When implemented via computer-executable instructions, various elements of embodiments for operating parsing and triaging programs are in essence the software code defining the operations of such various elements. The executable instructions or software code may be obtained from a readable medium (e.g., a hard drive media, optical media, EPROM, EEPROM, tape media, cartridge media, flash memory, ROM, memory stick, and/or the like) or communicated via a data signal from a communication medium (e.g., the Internet). In fact, readable media can include any medium that can store or transfer information.

FIG. 10 illustrates an example computer system 1000 adapted according to certain embodiments. That is, computer system 1000 comprises an example system on which embodiments of a parsing and/or triaging program as described herein may be implemented. Central processing unit (CPU) 1001 is coupled to system bus 1002. CPU 1001 may be any general purpose CPU. Embodiments of parsing and/or triaging programs are not restricted by the architecture of CPU 1001 as long as CPU 1001 supports the inventive operations as described herein. CPU 1001 may execute the various logical instructions according to some embodiments. For example, CPU 1001 may execute machine-level instructions according to the exemplary operational flows described above in conjunction with FIGS. 2, 3, and 6-9.

Computer system 1000 also preferably includes random access memory (RAM) 1003, which may be SRAM, DRAM, SDRAM, or the like. Computer system 1000 preferably includes read-only memory (ROM) 1004 which may be PROM, EPROM, EEPROM, or the like. RAM 1003 and ROM 1004 hold user and system data and programs, as is well known in the art.

Computer system 1000 also preferably includes input/output (I/O) adapter 1005, communications adapter 1011, user interface adapter 1008, and display adapter 1009. 1/0 adapter 1005, user interface adapter 1008, and/or communications adapter 1011 may, in certain embodiments, enable a user to interact with computer system 1000 in order to input information, such as instructions to a parsing program to aggregate failure signatures showing certain symptoms and/or criteria 514, 515, and 523, as examples.

I/O adapter 1005 preferably connects to storage device(s) 1006, such as one or more of hard drive, compact disc (CD) drive, floppy disk drive, tape drive, etc. to computer system 1000. The storage devices may be utilized when RAM 1003 is insufficient for the memory requirements associated with storing data. Communications adapter 1011 is preferably adapted to couple computer system 1000 to network 1012. Network 1012 may comprise the Internet or other Wide Area Network (WAN), a Local Area Network (LAN), Wireless Network, Public-Switched Telephony Network (PSTN), any combination of the above, or any other communication network now known or later developed that enables two or more computers to communicate with each other. Parsing and triaging can be distributed on network 1012 and/or the behavioral model testing may be performed on a networked computer and the results communicated via the network to a parsing program. User interface adapter 1008 couples user input devices, such as keyboard 1013, pointing device 1007, and microphone 1014 and/or output devices, such as speaker(s) 1015 to computer system 1000. Display adapter 1009 is driven by CPU 1001 to control the display on display device 1010 to, for example, display the failure modes to the test engineer.

It shall be appreciated that embodiments of a parsing and triaging program are not limited to the architecture of system 1000. For example, any suitable processor-based device may be utilized, including without limitation personal computers, laptop computers, computer workstations, and multi-processor servers. Moreover, embodiments of a parsing and/or triaging program may be implemented on application specific integrated circuits (ASICs) or very large scale integrated (VLSI) circuits. In fact, persons of ordinary skill in the art may utilize any number of suitable structures capable of executing logical operations according to the embodiments described above.

1. A method comprising:
receiving a failure signature into a parsing program;
aggregating by the parsing program the failure signature into a corresponding failure mode; and
prioritizing by the parsing program the failure mode according to a hierarchy.

2. The method of claim 1 in which the failure signature is derived from verification of a system under test.

3. The method of claim 2 in which the system under test comprises a behavioral model representing a hardware design.

4. The method of claim 3 in which the system under test comprises a behavioral model implemented in VHDL.

5. The method of claim 1 in which inputting a failure signature comprises:
inputting into the parsing program a test results file;
opening by the parsing program the test results file; and
logging by the parsing program information contained in the test results file.

6. The method of claim 1 wherein aggregating by the parsing program the failure signature into a corresponding failure mode comprises:
detecting a trait in the failure signature; and
correlating the failure signature with a second failure signature sharing the trait.

7. The method of claim 6 wherein the trait is a known bug symptom.

8. The method of claim 6 further comprising outputting the failure mode with an identifier associating the failure mode with the trait.

9. The method of claim 1 wherein aggregating by the parsing program the failure signature into a corresponding failure mode is controlled by instructions from a user.

10. The method of claim 9 wherein the instructions comprise a set of criteria defining a correlation between the failure signature and a second failure signature.

11. The method of claim 9 wherein the instructions are customized to a particular system under test.

12. The method of claim 1 wherein aggregating by the parsing program the failure signature into a corresponding failure mode comprises aggregating the failure signature without a specific instruction from a user to aggregate the failure signature.

13. The method of claim 1 wherein prioritizing the failure mode comprises:
determining the relative position in a hierarchy of the failure mode compared to a relative position in the hierarchy of a second failure mode; and
outputting the failure modes such that the failure mode determined to be of higher relative position in the hierarchy is output to a user before the other failure mode is output.

14. The method of claim 13 wherein the hierarchy is defined by a user.

15. The method of claim 13 further comprising allowing the user to change the hierarchy after the user has defined the hierarchy.

16. The method of claim 1 further comprising allowing a user to revise an operating characteristic of the parsing program.

17. The method of claim 1 further comprising outputting the failure mode to a triaging program.

18. A method comprising:
receiving a failure mode into a triaging program;
determining by the triaging program that the failure mode corresponds to a diagnosis; and
recording the failure mode in a directory corresponding to the diagnosis.

19. The method of claim 18 wherein receiving a failure mode comprises:
contacting a parsing program; and
requesting from the parsing program a failure mode.

20. The method of claim 18 further comprising defining the diagnosis such that the diagnosis is associated with known bug symptoms.

21. The method of claim 18 further comprising allowing a user to revise an operating characteristic of the triaging program.

22. The method of claim 21 wherein the operating characteristic is the diagnosis.

23. The method of claim 18 further comprising deleting one or more results files from a memory.

24. The method of claim 18 further comprising:
determining by the triaging program that a second failure mode does not correspond to a diagnosis; and
allowing a user to define the manner in which the triaging program handles the second failure mode.

25. A system comprising:
a results file comprising a failure signature;
a first set of determined criteria;
a second set of determined criteria;
a third set of determined criteria;
a database;
a parsing program that receives the results file, examines the failure signature, organizes the failure signature into a failure mode corresponding to the first set of determined criteria, prioritizes the mode according to the second set of determined criteria, and outputs the failure mode; and
a triaging program that receives the mode, associates the mode with a diagnosis according to the third set of determined criteria, and organizes the mode in a database according to its associated diagnosis.

26. The system of claim 25 wherein the first set of criteria, the second set of criteria, and the third set of criteria are unique to a particular system under test.

27. The system of claim 25 wherein the results file comprises information derived from verification of a system under test.

28. A computer program product having a computer readable medium having computer program logic recorded thereon, comprising:
code for inputting a plurality of failure signatures from a system under test into a parsing program;
code for aggregating by the parsing program those failure signatures into one or more failure modes;
code for prioritizing the failure modes according to pre-defined hierarchy;
code for outputting the failure modes in a format according to the pre-defined hierarchy;
code for inputting the failure modes into a triaging program;
code for determining by the triaging program that at least one of the failure modes corresponds to a pre-defined diagnosis; and
code for recording the at least one failure mode which corresponds to the diagnosis in a directory associated with the diagnosis.

29. The computer program product of claim 28 wherein the code for aggregating the failure signatures into one or more failure modes comprises code for checking each failure mode against every other failure mode for correlation.

30. The computer program product of claim 28 further comprising code for inputting instructions from a user, those instructions defining a method used by the parsing program to aggregate the failure signatures into one or more failure modes.

31. The computer program product of claim 28 further comprising code for inputting system status information from the system under test into the parsing program.

32. The computer program product of claim 31 wherein the code for outputting the failure modes comprises code for outputting the system status information.

33. The computer program product of claim 31 wherein the plurality of failure signatures is included in a results file.

34. The computer program product of claim 33 wherein the results file is divided into sections.

35. The computer program product of claim 33 wherein the results file is included in a batch.

36. The computer program product of claim 28 wherein the code for aggregating by the parsing program those failure signatures into one or more failure modes comprises code for determining that at least one of the plurality of failure signatures does not correlate to any other failure signature of the plurality.

37. The computer program product of claim 36 further comprising code for allowing a user to customize a handling of the at least one of the failure signatures that does not correlate to any other failure signature of the plurality.

38. The computer program product of claim 28 further comprising code for determining that at least one of the failure modes does not correspond to a diagnosis.

39. The computer program product of claim 38 further comprising code for allowing a user to customize a handling of the at least one failure mode that does not correspond to a diagnosis.

40. The computer program product of claim 28 wherein the system under test comprises a software design.

41. A failure tracking method comprising:
inputting a definition of a failure mode into a database;
accessing the definition of a failure mode by a parsing program;
inputting a failure signature from a system under test into the parsing program;
aggregating by the parsing program the failure signature into a failure mode according to the definition;
outputting the failure mode; and
examining the failure signature for correlation to the definition.

42. The method of claim 41 wherein accessing the definition of a failure mode by a parsing program is accomplished by the parsing program automatically after the definition is input.

43. A regression method comprising:
revising a system under test;
inputting a failure signature from the system under test into a parsing program;
aggregating by the parsing program the failure signature into a failure mode;
outputting the failure mode to a user; and
determining whether the failure mode corresponds to a failure mode associated with a previous version of the system under test.

44. The method of claim 43 further comprising:
determining that the failure mode corresponds to a new failure in a current version of the system under test; and
revising the current version of the system under test.

45. A system comprising:
means for receiving at least one failure signature indicating at least one error in a behavioral model for a device design relative to a reference model;
means for aggregating said at least one received error into at least one corresponding failure mode;
means for determining a corresponding diagnosis for the at least one failure mode; and
means for recording the at least one failure mode and its corresponding diagnosis.

46. The system of claim 45 further comprising:
means for prioritizing said at least one failure mode according to a defined hierarchy.

47. The system of claim 46 wherein said at least one corresponding failure mode comprises at least two failure modes, said means for prioritizing comprises:
means for determining the relative position in said defined hierarchy of a first one of the at least two failure modes compared to a relative position in the defined hierarchy of a second one of the at least two failure modes.

48. The system of claim 47 further comprising:
means for outputting the at least two failure modes in a manner indicating the failure mode determined to have a higher relative position in the defined hierarchy.

49. The system of claim 45 wherein said means for aggregating said at least one received error into at least one corresponding failure mode comprises:
means for detecting a common trait in a plurality of failure signatures received by the receiving means; and
means for correlating the plurality of failure signatures sharing the common trait into a common failure mode.

50. The system of claim 49 wherein the common trait is a known bug symptom.
